(19) United States
(12) Patent Application Publication
(10) Pub. No.: US 2015/0156020 A1
(43) Pub. Date: Jun. 4, 2015

(54) SYSTEMS AND METHODS FOR A FULLY ISOLATED ENCRYPTION KEY FILLING PORT

(71) Applicant: Microsemi Corporation, Aliso Viejo, CA (US)

(72) Inventors: Daniel P. Fogelson, Chandler, AZ (US); Robert V. Lazaravich, Chandler, AZ (US); Sabrina S. Pina, Phoenix, AZ (US); Kenneth R. Paxman, Chandler, AZ (US); Rudolph J. Sterbenz, Chandler, AZ (US)

(21) Appl. No.: 14/557,729

(22) Filed: Dec. 2, 2014

Related U.S. Application Data
(60) Provisional application No. 61/911,602, filed on Dec. 4, 2013.

(51) Int. Cl. H04L 9/08

(52) U.S. Cl. CPC H04L 9/0877

(57) ABSTRACT

Various storage devices may benefit from encryption technologies. For example, storage devices may benefit from systems and methods for a fully isolated encryption key filling port. A system can, for example, include a host connector installed in a host computer and configured to connect to a storage connector in a storage device. The system can also include a key fill device connected to the host connector. The key fill device may be configured to communicate data to the storage device via one or more pins in the host connector. The host computer may be configured to not use the one or more pins as data pins.

### CROSS-REFERENCE TO RELATED APPLICATION

The present application is related to and claims the benefit and priority of U.S. Provisional Patent Application No. 61/911,602, filed Dec. 4, 2013, the entirety of which is hereby incorporated herein by reference.

### BACKGROUND

1. Field

Various storage devices may benefit from encryption technologies. For example, storage devices may benefit from systems and methods for a fully isolated encryption key filling port.

2. Description of the Related Art

Data may be unprotected if it is not encrypted. Thus, storage products can include built-in encryption. A first generation of these products self-generated the encryption keys internally. In this approach, it is not possible to examine the encryption key. Thus, others cannot really be sure that the key is changing, or whether the key is random. Moreover, if the command to purge the key is given to the storage device, and the device purges the key, the data can never be retrieved.

In another generation of these products, a line of storage products can include a feature that allows the encryption key to be loaded by an end user of the device. This feature may allow the end user to purge the encryption, and then, at a later time, reload the key when the threat to the data is resolved. In this generation of products, the keys typically load from the same interface that the host system reads/writes the data on the storage device using the data communication path utilized to read/write date from the storage device.

For example, the current method to load encryption keys on standardized interfaces shares the key fill port with the standard data lines of the data port or uses a particular separate connector, which adds to cost.

Specifically, the keys are either internally generated, or loaded directly thru the same storage interface, and lines, that passes read/write data, or the above mentioned particular separate connector. For example, if the storage interface was a serial advanced technology attachment (SATA), the conventional approach is to load the keys using a SATA command, with the keys being loaded along the standard SATA data path. Thus, the storage device must inherently exhibit an access path between the standard SATA data path and the storage location for the loaded keys. The existence of this access path means that the loaded keys are thus vulnerable to access by a host computer which may have been loaded with hacking software.

### SUMMARY

According to certain embodiments of the present invention, a system can include a host connector installed in a host computer and configured to connect to a storage connector in a storage device. The system can also include a key fill device removably connected to the storage connector of the storage device. The key fill device may be configured to communicate data to the storage device via one or more pins in the storage connector. The host computer may be configured to not use the one or more pins as data pins.

In certain embodiments of the present invention, a system can include a storage connector installed in a storage device and configured to connect to a host connector in a host computer. The system can also include circuitry configured to process a key received from a key fill device connected to the storage connector. The storage device may be configured to receive communication from the key fill device via one or more pins of the storage connector. The host computer may be configured to not use the one or more pins as data pins.

A system, according to certain embodiments of the present invention, can include a storage device and a host connector installed in a host computer and configured to connect to a storage connector in the storage device. The system can also include a key fill device removably connected to the storage connector of the storage device. The key fill device may be configured to communicate data to the storage device via one or more pins in the storage connector of the storage device. The host computer may be configured to not use the one or more pins as data pins.

A method, in certain embodiments of the present invention, can include removably connecting a key fill device to a storage connector of a storage device. The storage connector can be configured to connect to a host connector of a host computer. The method can also include filling a key from the key fill device to the storage device over one or more pins of the storage connector. The host computer may be configured to not use the one or more pins as data pins.

### BRIEF DESCRIPTION OF THE DRAWINGS

For proper understanding of the invention, reference should be made to the accompanying drawings, wherein:

FIG. 1A illustrates a simplified block diagram of a system according to certain embodiments of the present invention.

FIG. 1B illustrates a simplified block diagram of another system according to certain embodiments of the present invention.

FIG. 2 illustrates a simplified block diagram of a system according to certain embodiments of the present invention.

FIG. 3 illustrates a method according to certain embodiments of the present invention.

FIG. 4 illustrates several SATA connectors.

FIG. 5 illustrates modified use of a SATA connector with combined signal and power segments according to certain embodiments of the present invention.

FIG. 6 illustrates another modified use of a SATA connector with combined signal and power segments according to certain embodiments of the present invention.

FIG. 7 illustrates a further modified use of a SATA connector with combined signal and power segments according to certain embodiments of the present invention.

FIG. 8 illustrates modified use of a SATA connector with a signal segment according to certain embodiments of the present invention.

### DETAILED DESCRIPTION

Certain embodiments of the present invention may help to secure an encryption key fill operation. For example, certain embodiments can fully isolate data loaded via the key fill port from any other data port on the storage device. Full isolation from the standard storage data interface can ensure that a hacked, corrupted, or malfunctioning host cannot access the encryption keys, passwords, or other authentication data located in the secure storage device.

For example, certain embodiments of the present invention can take advantage of unused, legacy, or redundant pins on a storage device to host interface connector. In certain embodiments of the present invention, the isolated key fill port can replace or combine with power or ground pins on a power segment of a SATA connector. This approach may allow the storage device interface to remain unchanged, yet support a fully isolated key fill port. A two-pin serial protocol is an exemplary interface for the key fill port.

As an example, for a standard SATA hard drive, pins P13, P14, and P15 may be used for 12 V power and pins P1, P2, and P3 may be used for 3.3V. A key fill port can, in certain embodiments of the present invention, reside on pins P14 and P15. P14 can implement a serial receive line and pin P15 can implement a serial transmit line. Running a cable from these two pins to a standard defense-grade key-fill device, and internally connecting these two pins to a key storage location, may be one way to provide a fully secure, isolated serial encryption key-fill port on a standard SATA hard drive or SSD. The cable that runs from the key fill transmit and key fill receive signals to the key fill device may use voltage translation to match standard key fill device voltage levels. Thus, the cable may be supplied as a translator cable.

While most current SATA storage devices do not use 12V power pins, some may. If an isolated key fill port is necessary for storage products that use the 12 V pins, there are other options. The SATA connector also has 3.3V pins that are mostly unused, that may be utilized as an isolated key fill port in place of the unused 12 V pins described above. In yet another embodiment, the serial key fill signals can be embedded onto the power signals, for example summed into the 12 V, so that the 12 V power line can also serve to carry the serial key fill signals. In such an embodiment, power for the storage device, and isolated key data, may be provided in a single set of pins.

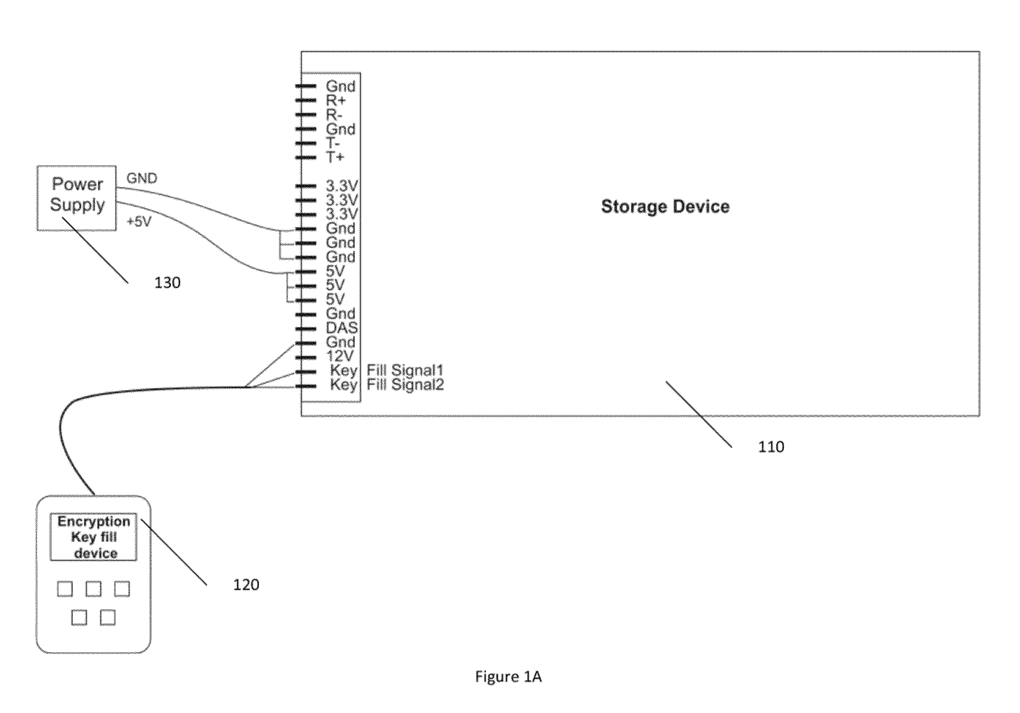

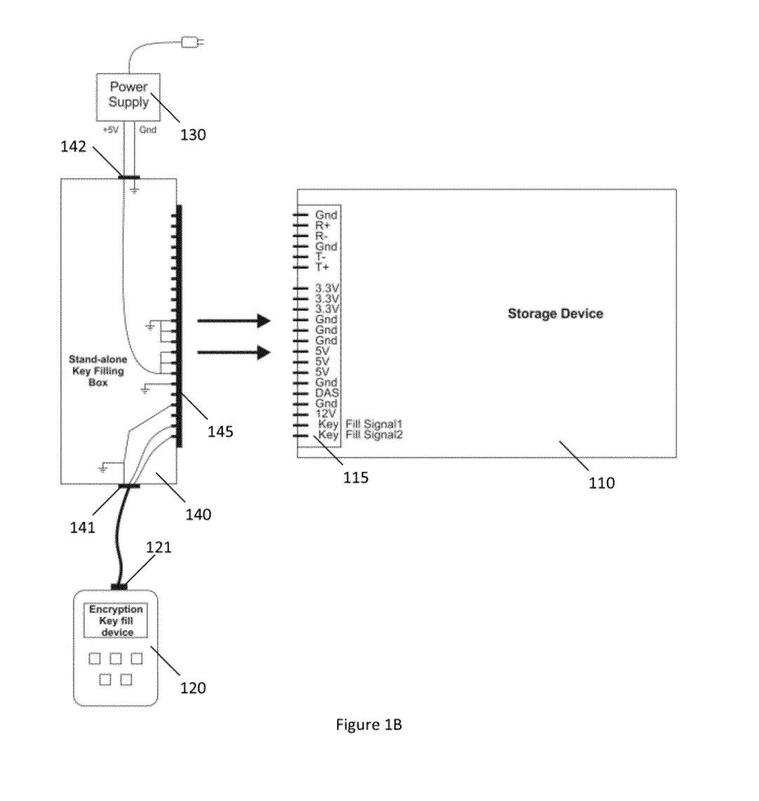

FIG. 1A illustrates a simplified block diagram of a system according to certain embodiments of the present invention. As shown in FIG. 1A, the system can include a storage device 110, such as a SATA storage device. The storage device 110 can be connected by key fill pins to an encryption key fill device 120. The key fill pins can be pins that would otherwise be 12 V pins, for example that are defined as 12 V pins in accordance with the SATA standard published by the Serial ATA International Organization. This may be a departure from a standard pin out for the interface. Although a SATA storage device is one example, small computer system interface (SCSI), serial attached SCSI (SAS), parallel advanced technology attachment (PATA), and fibre channel (FC) storage devices are also permitted. A hard drive is one example a storage device.

The diagram is an example of a system that can use some of the described methods to implement isolated key-filling on, for example, a SATA interface. The methods, however, may be applicable to other storage interfaces.

Thus, for example, certain embodiments of the present invention may provide for encryption key filling using an existing electrical interface of the secure storage device with full data isolation of the key fill port with minimal impact to the existing storage interface or design. No additional connectors may be necessary between the storage device and the key fill device, so the form factor can be the same as if the key fill port were not included. Since the key fill port may not use shared data signals, the key fill port, and internal storage of the loaded keys, can be fully isolated from device data ports, and thus access from a host computer connected to the interface can be blocked.

Certain embodiments of the present invention can be variously implemented. For example, certain embodiments of the present invention can provide a fully isolated secure encryption key fill port using unused, legacy, or redundant pins on the storage to host interface connector. For example, power pins that are unnecessary for other operations of the storage device can be used. Key fill data can be superimposed on the power pins if, for example, there are no other available pins. Typically, encryption key fill device 120 is connected to storage device 110 when storage device 110 is not connected to a host computer, however this is not meant to be limiting. Power may then be supplied to at least one of the other power and ground pins from encryption key fill device 120, or another power source, to enable operation of key storage circuitry on storage device 110.

Thus, no new and additional connectors or ports may be needed. Some high capacity storage devices may have little room for new connectors. Thus, certain embodiments of the present invention may benefit such devices as well as devices that must fit into the same industry standard form-factor as before the key fill port is added.

A serial interface can be used in certain embodiments of the present invention. The serial interface may be useful in the case of, for example, connecting to defense grade key fill devices.

The system shown in FIG. 1A can also include a power supply 130. The power supply 130 can include, for example, lines or 5V and ground (GND). The power supply 130 can attach to appropriate pins on the storage device 110. The power supply 130 is shown as separate from encryption key fill device 120, but can be integral therewith. Alternatively, the power supply 130 could be integral with storage device 110.

FIG. 1B illustrates a simplified block diagram of another system according to certain embodiments of the present invention. Like the system of FIG. 1A, the system of FIG. 1B can include a storage device 110, encryption key fill device 120, and power supply 130. The system can further include a stand-alone key filling box 140.

The stand-alone key fill box 140 can be used to simplify the key filling wiring. The stand-alone key fill box 140 can have an intermediate connector 145 that connects to storage connector 115 of the storage device 110. The intermediate connector 145 can follow the same standard as storage connector 115 of the storage device 110.

The stand-alone key fill box 140 can include one or more key filling connector 141, which can accept a cable from encryption key fill device 120. Alternatively, the cable can be included with the stand-alone key fill box 140 and can connect to a port 121 in the encryption key fill device 120.

The stand-alone key fill box 140 can also include one or more power connector(s) 142 for an AC powered power supply 130 that makes, in this example, 5V for the storage device 110. The storage device 110 may need external power to accept a key from encryption key fill device 120. The stand-alone key fill box 140 may have no electronics in it, just connections from all the connectors to the storage connector 115, as shown. Alternatively, electronics can be incorporated into the stand-alone key fill box 140, for example, to ensure that the stand-alone key fill box 140 has not been subject to tampering. Further the key fill box can include one or more small batteries to supply power to device 110 for the duration needed to fill keys.

Various embodiments of the present invention may be broadly applicable to numerous interfaces and systems. For example, certain embodiments of the present invention can be applied to many different storage device interface standards, including SATA, SAS, SCSI, PATA and others. Thus, for example, the connectors can be standards-based connectors.

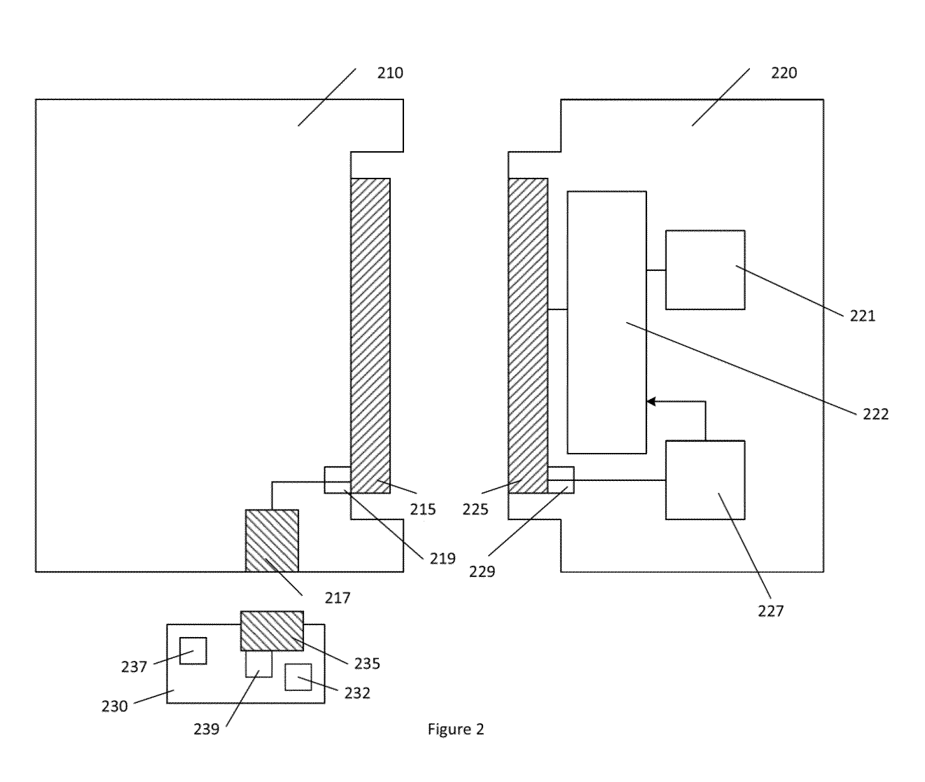

FIG. 2 illustrates a simplified block diagram of a system according to certain embodiments of the present invention. As shown in FIG. 2, a system can include a host device such as host computer 210, which may be, for example, a laptop computer or a desktop computer. Other devices can also serve as host devices.

The system can also include a host connector 215 installed in the host computer 210. The system can further include a storage device 220, for example a hard disk drive or a solid state drive, such as storage device 110, shown in FIGS. 1A and 1B. The host connector 215 can be configured to connect to a storage connector 225 in the storage device 220. The host connector 215 can be a standard connector, and likewise the storage connector 225 can be a standard connector. The standard connectors can be at least one of a SATA connector, a SAS connector, a SCSI connector, or a PATA connector. Other standard connectors are also permitted. Thus, the host connector 215 can be, or include, a serial interface or a parallel interface.

The system can also include a key fill device 230 removably connectable to the storage connector 225. The key fill device 230 can be similar to the encryption key fill device 120, shown in FIGS. 1A and 1B. In FIG. 2, the parts are shown separated for easier viewing.

The key fill device 230 can be configured to communicate data to the storage device 220 via one or more pins in the storage connector 225. The pins are not shown in detail in FIG. 2, but FIGS. 1A and 1B show various pins in greater detail. As defined by a standard the one or more pins can be other than data pins. Thus, in certain embodiments the host computer is configured to not use the one or more pins as data pins. The one or more pins can include a pin designated by a third party standard as a power pin. Additionally, the one or more pins can include at least one pin designated by a third party standard as a no connect pin, a reserved pin, a status pin or a ground pin. The one or more pins can be exactly one power pin or exactly two power pins as designated by a third party standard. Moreover, the one or more pins can be 12V power pins, or 5V power pins, or 3.3V power pins, or other power pins designated by a third party standard. If a single pin is used, the communication on the pin may be bi-directional communication. If bi-directional communication uses differential logic, then two or more pins may be used for bi-directional communication.

Other pins can also or alternatively be used. For example, any status pins, such as a DAS pin in a SATA connector, or other signal pins that are not used by the host computer for communicating data, can be used. These can include any pins that are left floating at the host computer side, either by a third party standard or by the specifications of the manufacturer of the host computer. For example, even if a pin is considered a data pin by a third party standard, if the host computer lacks a configuration for using the pin to send or receive data, the pin may be eligible for use in certain embodiments.

In such an embodiment, the key fill device 230 is configured to communicate the data to the storage device 220 while isolating the data from data processing by the host computer 210.

The host computer 210 can include an external interface 217 providing a direct connection to the one or more pins, without passing through any data processing in the host computer. The key fill device 230 can be configured to connect to the external interface 217 by its own interface 235. The key fill device 230 can be connected to the one or more pins by a cable, which may lie between the external interface 217 and the host connector 215.

The host computer 210 can be configured to drive a plurality of data pins of the host connector 215 to ground when the key fill device 230 communicates data to the storage device 220. This may be done to prevent the temporarily grounded pins from being used to communicate or monitor data. The plurality of data pins can be all of the data pins of the host connector 215.

The host computer 210 can include a protection circuit 219 to filter ripple caused by the data communicated by the key fill device 230. The storage device 220 can also or additionally include a protection circuit 229 to filter ripple caused by the data communicated by the key fill device 230. Similarly, a filter circuit 239 can be provided in the key fill device 230. These and other filter circuits may be used in a variety of embodiments, including in cases where power and data are supplied on a single pin.

The key fill device 230 can include an analog circuit 232 configured to modulate or sum a key fill signal onto a power voltage on the one or more pins. The key fill device 230 can further include a key storage memory 237. The key storage memory 237 can be a read only memory (ROM) or can be a random access memory that can be updated by a user. A key can be stored in the key storage memory 237 or can be generated based on information stored in the key storage memory 237.

The storage device 220 can include a main memory 221, which can provide storage to be used or accessed by the host computer 210. The storage device 220 can also include an encryption device 222, which can serve as a translator between the main memory 221 and any external interface.

The storage device 220 can include a storage connector 225, as mentioned above. This storage connector 225 can be configured to connect to the host connector 215 in the host computer 210. The storage device 220 can also include circuitry 227 configured to store and/or process a key received from the key fill device 230 via connector 217, which can be connected to the particular pins on host connector 215 and thereby to the corresponding particular pins on storage connector 225. Circuitry 227 may be designed to store the key as received, or first process the key prior to storing a resultant product.

Thus, the storage device 220 can be configured to receive communication from the key fill device 230 via one or more pins of the host connector 215 and the storage connector 225. Circuitry 227 can be isolated from any data path on storage device 220 or host computer 210. For example, a one-way path can connect the circuitry 227 and the encryption device 222. Thus, keys stored on circuitry 227 cannot be accessed by host computer 210.

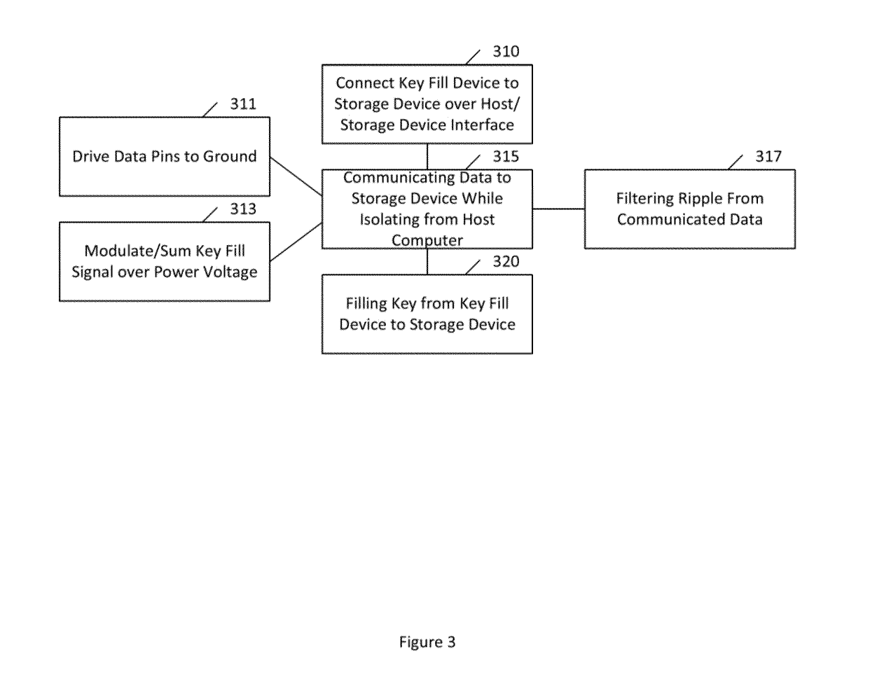

FIG. 3 illustrates a method according to certain embodiments of the present invention. As shown in FIG. 3, the method can include, at 310, connecting a key fill device to a storage device over the host/storage device interface. The method can also include, at 320, filling a key from the key fill device to a storage device connected via, for example, a storage connector of a storage device. The storage connector can be configured to connect to a host connector of a host device, such as a host computer. The storage connector and host connector can correspond to one another and can be standards-based connectors, such as SCSI, SATA, PATA, or the like. The method can also include, at 315, communicating the key data to a dedicated storage location on the storage device while isolating the key data from data processing access by the host computer. For example, the host computer is, in certain embodiments, configured to not use the one or more pins as data pins.

Also, the method can include, at 311, driving a plurality of data pins of the connector to ground when the key fill device communicates data to the storage device. The method can further include, at 313, modulating or summing a key fill signal onto a power voltage on the one or more pins. The method can additionally include, at 317, filtering ripple caused by the key data communicated by the key fill device, when the key data is transmitted modulated onto the power voltage.

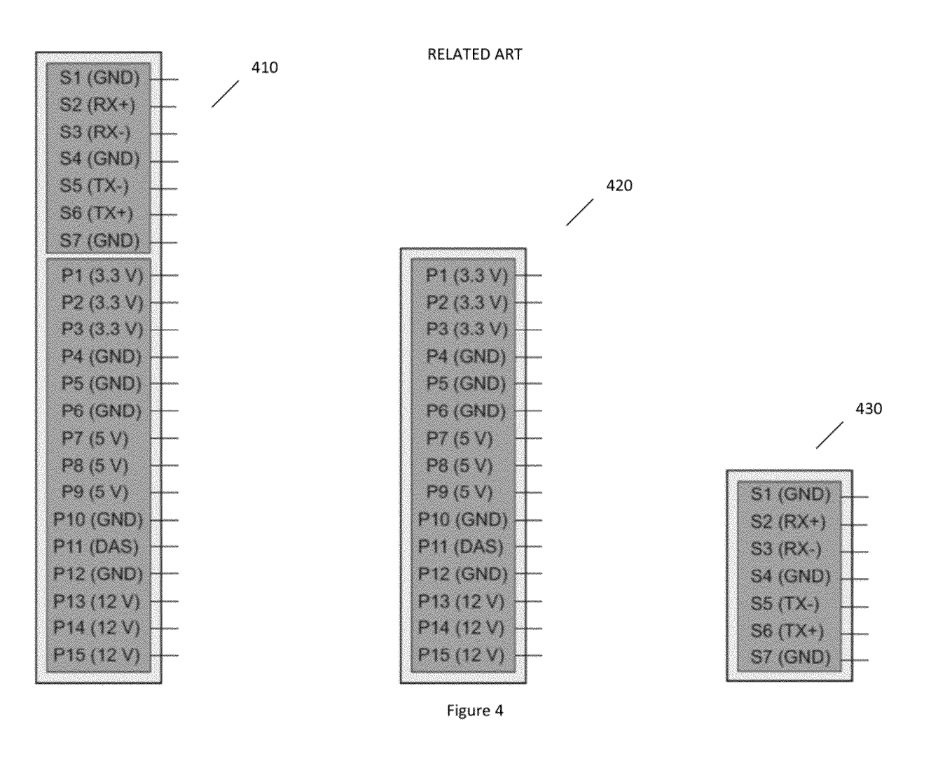

FIG. 4 illustrates several SATA connectors. As shown in FIG. 4, there are a variety of possible connectors between a storage device and a host computer. For example, there can be a SATA connector with combined signal and power segments 410, a SATA connector with a power segment 420, and a SATA connector with a signal segment 430. Other connectors are also permitted.

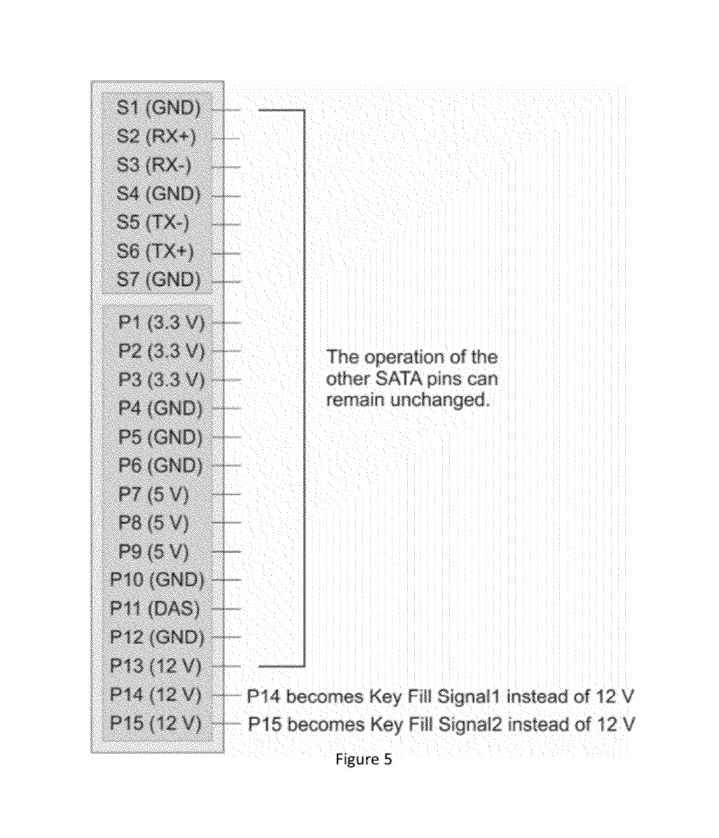

FIG. 5 illustrates modified use of a SATA connector with combined signal and power segments according to certain embodiments of the present invention. As shown in FIG. 5, the operation of most of the pins can remain as normal for a SATA connector. However, pins P14 and P15 can have modified usage. For example, P14 can become a key fill reception (RX) or serial data (SDA) signal instead of 12 V. Likewise, P15 can become a key fill transmission (TX) or serial clock (SCL) signal instead of 12 V. In applications using differential signaling, for example, when using a RS-485 protocol, P15 and P16 can interchangeably become the bi-directional D+ or D− signals.

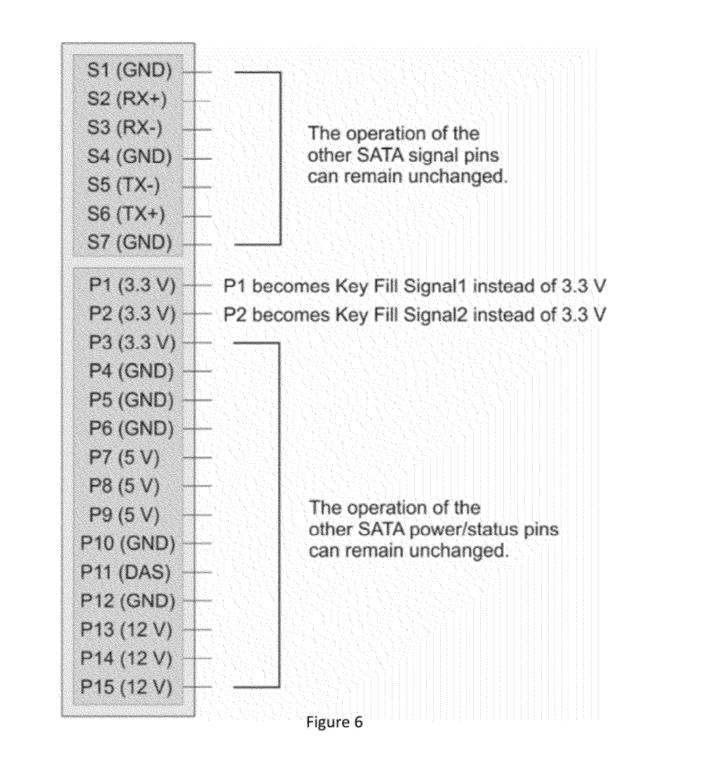

FIG. 6 illustrates another modified use of a SATA connector with combined signal and power segments according to certain embodiments of the present invention. In this case, pins P1 and P2 have modified operation, while the operation of the other pins can remain unchanged. For example, P1 can become key fill RX or SDA signal and P2 can become key fill TX or SCL signal, instead of 3.3 V.

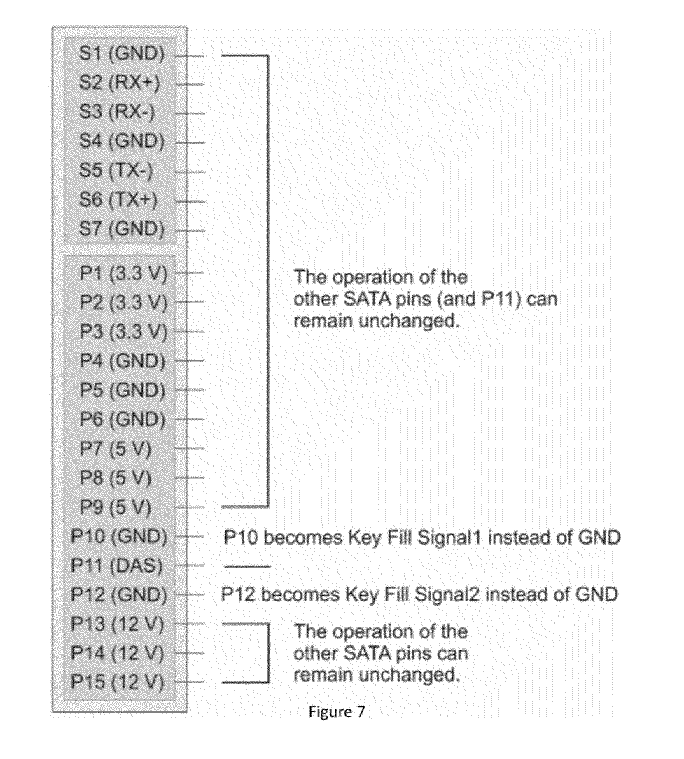

FIG. 7 illustrates a further modified use of a SATA connector with combined signal and power segments according to certain embodiments of the present invention. In this case, the modified pins can be pins P10 and P12. Rather than ground (GND), these pins can respectively become key fill RX or SDA signal and key fill TX or SCL signal.

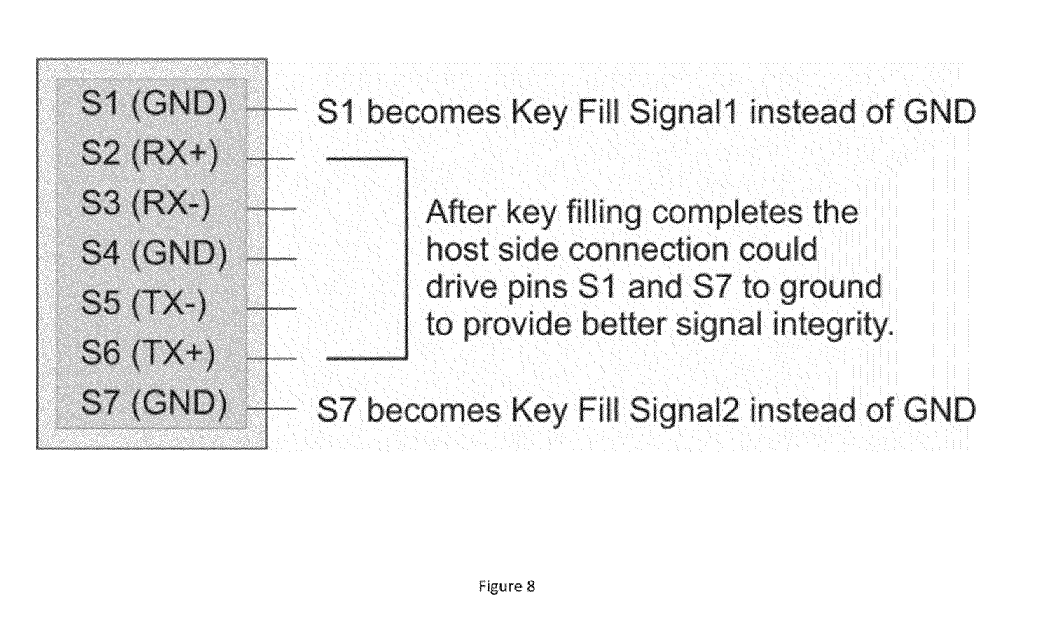

FIG. 8 illustrates modified use of a SATA connector with a signal segment according to certain embodiments of the present invention. In this case, rather than GND, pins S1 and S7 can respectively become key fill RX or SDA signal and key fill TX or SCL signal. The other signal pins can be driven to ground during the key filling, and pins S1 and S7 can be driven to ground once key filling is completed. This driving to ground can be performed at the host-side connection.

Other cabling configurations are also permitted. For example, one permitted configuration is RS-485. RS-485 can use a differential pair of signals Data+ and Data− to communicate data. These two signals can be equivalent or similar to TX and RX or SDA and SCL, respectively.

One having ordinary skill in the art will readily understand that the embodiments of the present invention, as discussed above, may be practiced with steps in a different order, and/or with hardware elements in configurations which are different than those which are disclosed. For example, the voltage levels identified may be varied to other voltage levels. Therefore, although the invention has been described based upon the disclosed exemplary embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A system, comprising:
a host connector installed in a host computer and configured to connect to a storage connector in a storage device; and
a key fill device removably connected to the storage connector of the storage device,
wherein the key fill device is configured to communicate data to the storage device via one or more pins in the storage connector, wherein the host computer is configured to not use the one or more pins as data pins.

2. The system of claim 1, wherein the one or more pins comprises one or more power pins.

3. The system of claim 1, wherein the one or more pins comprise at least one of a no connect pin, a reserved pin, a status pin, or a ground pin.

4. The system of claim 1, wherein the host connector comprises a standard connector.

5. The system of claim 4, wherein the standard connector comprises at least one of a SATA connector, a SAS connector, a SCSI connector, or a PATA connector.

6. The system of claim 1, wherein the one or more pins consist of one power pin or two power pins.

7. The system of claim 1, wherein the one or more pins comprise one or more 12V power pins or one or more 3.3V power pins or one or more 5.0V power pins or one or more of the pins defined to provide power to the storage connector.

8. The system of claim 1, wherein the host connector comprises a serial interface.

9. The system of claim 1, wherein the storage device is configured to receive data from the key fill device over the one or more pins in the storage connector and store same in circuitry not accessible by the host computer, said received data thus fully isolated from data processing by the host computer.

10. The system of claim 1, wherein the host computer comprises an external interface providing a direct connection to the one or more pins, without passing through any data processing in the host computer, wherein the key fill device is configured to connect to the external interface.

11. The system of claim 1, wherein the key fill device is connected to the one or more pins by a cable.

12. The system of claim 1, wherein the host computer is configured to drive a plurality of data pins of the host connector to ground when the key fill device communicates data to the storage device.

13. The system of claim 12, wherein the plurality of data pins comprises all of the data pins of the host connector.

14. The system of claim 1, wherein the host computer comprises a protection circuit to filter ripple caused by the data communicated by the key fill device.

15. The system of claim 1, wherein the key fill device comprises an analog circuit configured to modulate or sum a key fill signal onto a power voltage on the one or more pins.

16. The system of claim 1, wherein the storage device comprises at least one of a hard disk drive or a solid state drive.

17. The system of claim 1, wherein the key fill device is configured to communicate the data comprising at least one of key fill data and security meta-data.

18. A system, comprising:
a storage connector installed in a storage device and configured to connect to a host connector in a host computer; and
circuitry configured to store or process a key received from a key fill device connected to the storage connector,
wherein the storage device is configured to receive communication from the key fill device via one or more pins of the storage connector, wherein the host computer is not configured to use the one or more pins as data pins.

19. The system of claim 18, wherein the one or more pins comprises one or more power pins.

20. The system of claim 18, wherein the one or more pins comprise at least one of a no connect pin, a reserved pin, a status pin, or a ground pin.

21. The system of claim 18, wherein the storage connector comprises a standard connector.

22. The system of claim 21, wherein the standard connector comprises at least one of a SATA connector, a SAS connector, a SCSI connector, or a PATA connector.

23. The system of claim 18, wherein the one or more pins consist of one power pin or two power pins.

24. The system of claim 18, wherein the one or more pins comprise one or more 12V power pins or one or more 3.3V power pins or one or more 5.0V power pins or one or more of the pins defined to provide power to the storage connector.

25. The system of claim 18, wherein the storage connector comprises a serial interface.

26. The system of claim 18, wherein the storage device comprises at least one of a hard disk drive or a solid state drive.

27. A system, comprising:
a storage device;
a host connector installed in a host computer and configured to connect to a storage connector in the storage device; and
a key fill device removably connected to the storage connector of the storage device,
wherein the key fill device is configured to communicate data to the storage device via one or more pins in the storage connector of the storage device, wherein the host computer is not configured to use the one or more pins as data pins.

28. The system of claim 27, wherein the one or more pins comprises one or more power pins.

29. The system of claim 27, wherein the one or more pins comprises at least one no connect pin, at least one reserved pin, or at least one status pin.

30. The system of claim 27, wherein the storage connector comprises a standard connector.

31. The system of claim 30, wherein the standard connector comprises at least one of a SATA connector, a SAS connector, a SCSI connector, or a PATA connector.

32. The system of claim 27, wherein the one or more pins consist of one power pin or two power pins.

33. The system of claim 27, wherein the one or more pins comprise one or more 12V power pins or comprise one or more 3.3V power pins or one or more 5.0V power pins or one or more of the pins defined to provide power to the storage connector.

34. The system of claim 27, wherein the host connector comprises a serial interface.

35. The system of claim 27, wherein the storage device comprises at least one of a hard disk drive or a solid state drive.

36. A method, comprising:
removably connecting a key fill device to a storage connector of a storage device, wherein the storage connector is configured to connect to a host connector of a host computer; and
filling a key from the key fill device to the storage device of the host computer over one or more pins of the storage connector, wherein the host computer is not configured to use the one or more pins as data pins.

37. The method of claim 36, further comprising:
communicating the data to the storage device while isolating the data from data processing by the host computer.

38. The method of claim 36, further comprising:
driving a plurality of data pins of the connector to ground when the key fill device communicates data to the storage device.

39. The method of claim 36, further comprising:
modulating or summing a key fill signal onto a power voltage on the one or more pins.

40. The method of claim 36, further comprising:
filtering ripple caused by the data communicated by the key fill device.
